(19) United States
(12) Patent Application Publication
(10) Pub. No.: US 2009/0150579 A1
(43) Pub. Date: Jun. 11, 2009

(54) WIRE CONNECTION ASSEMBLY FOR CONNECTING A COMPUTER MAINFRAME WITH AN EXTERNAL DEVICE

(76) Inventor: Brian Hsu, Taipei Hsien (TW)

Correspondence Address: Brian Hsu, 235 Chung - Ho, Box 8-24, Taipei, TW

(21) Appl. No.: 12/109,351

(22) Filed: Apr. 25, 2008

(30) Foreign Application Priority Data
Dec. 5, 2007 (TW) 096220592

(51) Int. Cl. G06F 13/12

(52) U.S. Cl. 710/64

(57) ABSTRACT

A wire connection assembly for connecting a computer mainframe and an external device includes an arranging portion, a connector, a wire winder, and a signal control panel. The arranging portion, the wire winder, and the signal control panel are compatible to a computer mainframe, and the connector is compatible to the arranging portion, wherein the wire winder can reel in or release a signal transmission cable therein, an end of the signal transmission cable connects to the connector, and the other end connects to the signal control panel. The connector has an installing portion which is installable to or detachable from the compatible arranging portion, an electrical connection is provided through the installation between the connector and the external device and through the wire winder the connector can be dragged away from a computer mainframe and remains connected.

### FIELD OF INVENTION

The present invention relates to wire connection assemblies, and in particular to a wire connection assembly providing a mechanical and electrical connection for a computer mainframe and an external device.

### BACKGROUND OF THE INVENTION

With the increasing capacity of the electronic storage media, the relative applications become more popular and practical. Such as a digital camera, a digital walkman (like an IPOD), a PDA, and other consuming electronics are benefited by the better functions and entertainment and so being widely used.

A user usually edits or accesses the mentioned devices through the connection with a personal computer. The downloading and uploading of data is not beyond the scope of a wiring transmission or a wireless transmission. For the wiring transmission, a user must prepare a transmission cable connected between a computer mainframe and an external device, but it is not only disorder a surrounding but also disturbing for a user to preserve the cable from buying a new one if it is lost. Furthermore, a frequently plug and unplug of the transmission cable can be a load of a compatible interface of a computer mainframe and is damageable too. Therefore, a prior art provides a cassette assembly which is built in a computer mainframe and compatible to an external device to surmount the disadvantage of the connection through a transmission cable, but this prior art will need a great space of a panel of a computer mainframe to install a cassette for a compatible external device. This is harmful to product miniaturization and a waste of a buyer who doesn't have those external devices (such as an I Pod mentioned in the patent). Furthermore, in accordance with the prior art, an external device can only be inserted into a cassette while using, for example of an I Pod, a user might be difficult to plug an earphone, view photographs through a display, record, or use other supported function while inserting the device into the cassette.

### SUMMARY OF THE PRESENT INVENTION

Accordingly, the primary object of the present invention is to provide a new wire connection assembly for connecting a computer mainframe to an external device, in that a user don't need an external transmission cable to connect an external device to a computer mainframe, and a external device can be installed to a computer mainframe or be dragged from a computer mainframe and still remains connected. This is the main objective of the present invention.

To achieve above object, the present invention provides a wire connection assembly of a computer mainframe and an external device comprising: an arranging portion, a connector, a wire winder, and a signal control panel; the arranging portion, the wire winder, and the signal control panel compatible to a computer mainframe, and the connector compatible to the arranging portion. The wire winder serves to reel or release a signal transmission cable received therein, and one end of the signal transmission cable is connected to the connector, and the other end thereof is connected to the signal control panel.

The benefits of the present invention including:

1. A computer mainframe can save a space of a panel without installing a cassette for a corresponding external device, and for the product of the same function, it is good for mass production and is economical to a computer mainframe maker.

2. An external device can be installed to a computer mainframe without exposing the connected transmission cable and thus maintains a clean surrounding. An external device can also be dragged from a computer mainframe with the transmission cable built in the computer mainframe for the usage of the supported function of the external device.

The various objects and advantages of the present invention will be more readily understood from the following detailed description when read in conjunction with the appended drawing.

The various objects and advantages of the present invention will be more readily understood from the following detailed description when read in conjunction with the appended drawing.

### BRIEF DESCRIPTION OF THE DRAWINGS

FIG. 1 is a main structure view of the present invention.

FIG. 2 is a perspective view showing a connection between an external device and a computer mainframe of the present invention.

FIG. 3 is a perspective view showing a preferable application of a connection between an external device and a computer mainframe of the present invention.

FIG. 4 is a perspective view showing the connection between a signal control panel, a connector, and a wire winder of the present invention.

FIG. 5 is a cross sectional view showing an external device installing to the connector of the present invention.

FIG. 6 is a cross sectional view showing an external device detaching from the arranging portion according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

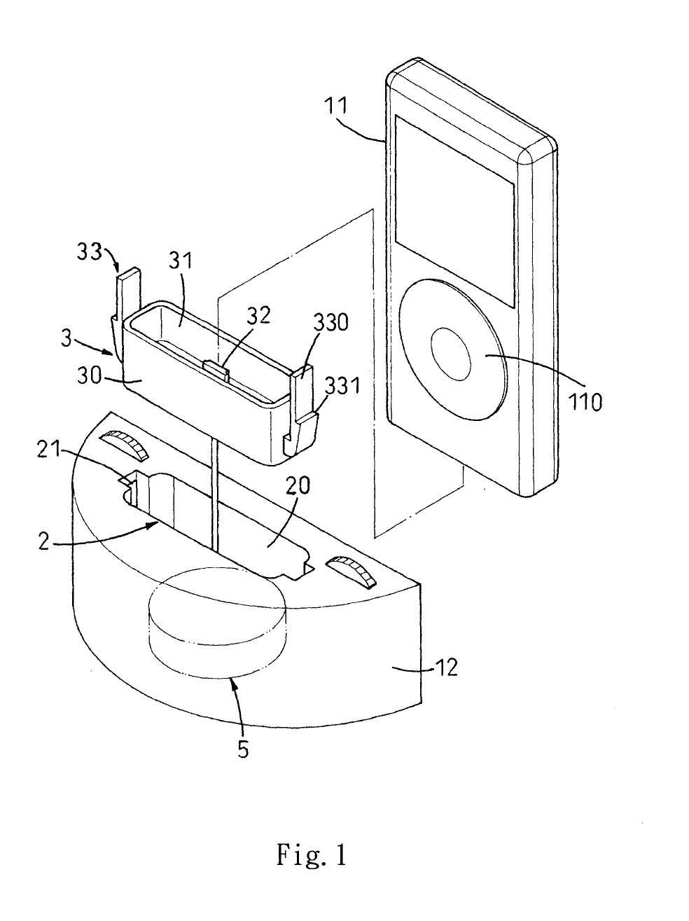

With reference to FIGS. 1 to 4, the wire connection assembly for a computer mainframe 10 and an external device 1 is illustrated. The assembly has the following elements.

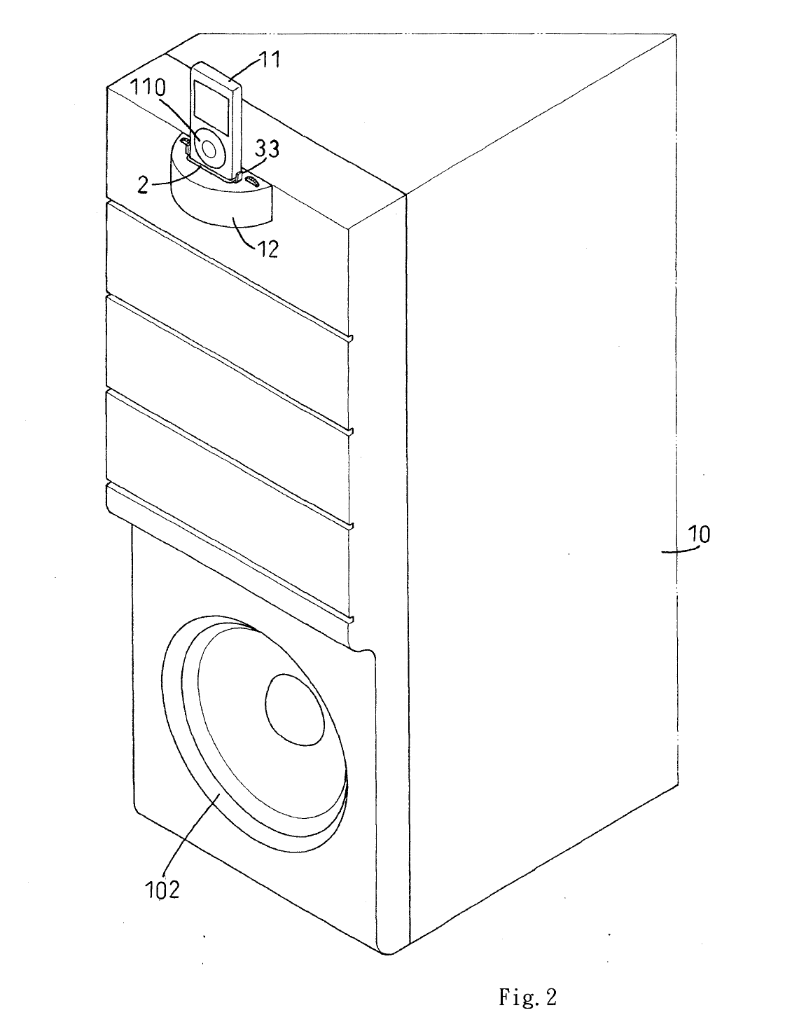

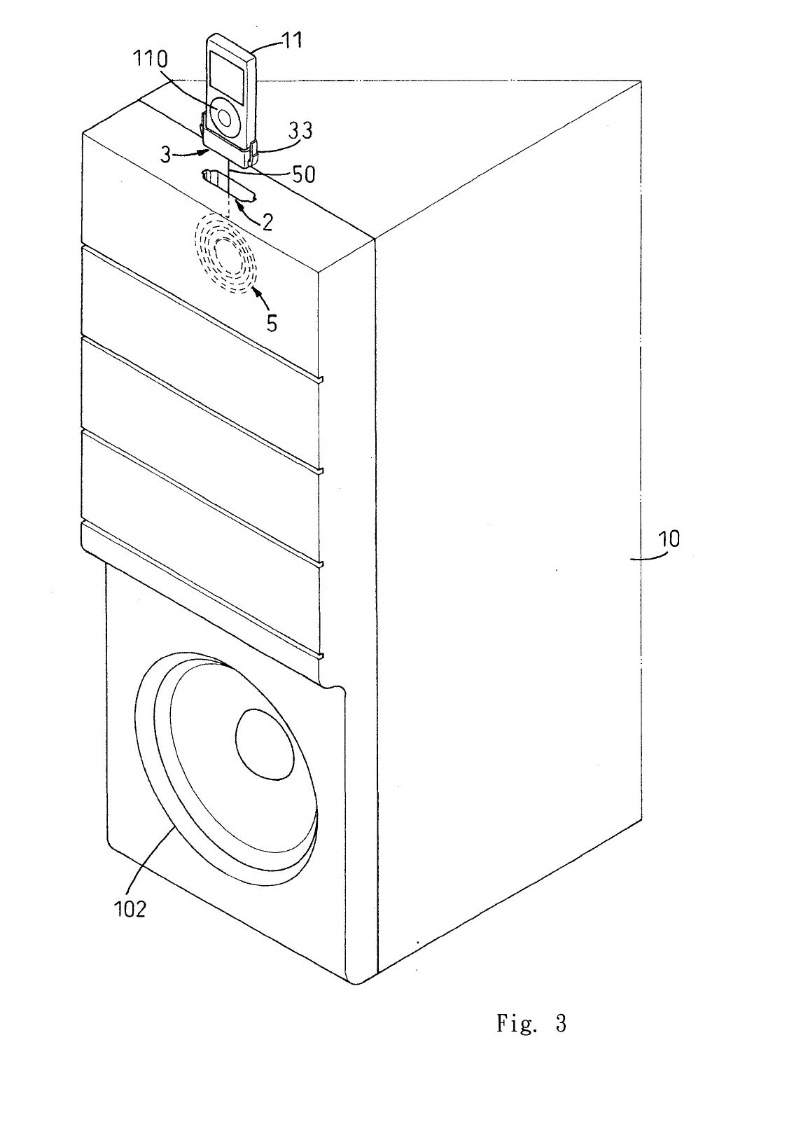

An arranging portion 2 is compatible to a computer mainframe 10. As shown in FIGS. 1 and 2, in this embodiment, the arranging portion 2 is formed in a carrier seat 12 installed to the computer mainframe 10, or as shown in FIG. 3, the arranging portion 2 is directly built in the computer mainframe 10. The arranging portion 2 has a receiving hole 20. Each of two opposite inner sides of the receiving hole 20 has a slot 21.

A connector 3 has a main portion 30 compatible to the receiving hole 20, an insertion portion 31 compatible to a mechanic specification of an external device 11, a guide portion 32 compatible to an electric specification of the external device 11 and an installing portion 33 installable to or detachable from the arranging portion 2. The installing portion 33 includes an operation sheet 330 and a bulged resisting portion 331. The operation sheet 330 serves to drive the resisting portion 331 to cause the installing portion 331 to be buckled to the slot 21 so that the connector 3 is installed in the receiving hole 20 or the operation sheet 330 drives the resisting portion 331 to leave form the slot 21 so that the connector 3 is detached from the receiving hole 21 of the arranging portion 2.

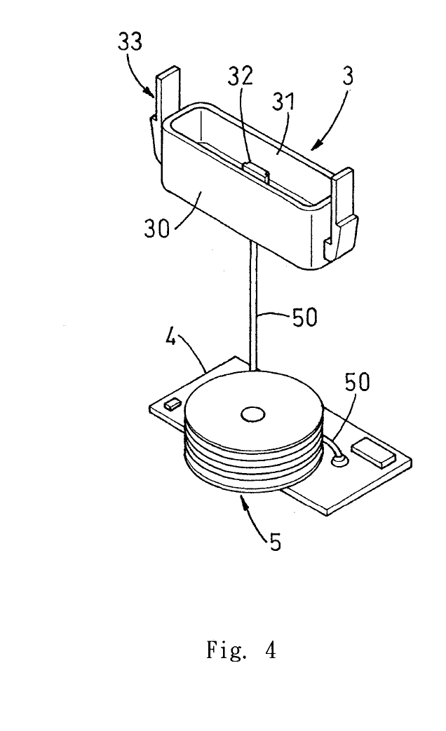

A signal control panel 4, as shown in FIG. 4, is compatible to a computer mainframe 10. As illustrated in FIGS. 1 and 2, the signal control panel 4 is formed in the carrier seat 12 installed to the computer mainframe 10, or as shown in FIG. 3. The signal control panel 4 is directly built in the computer mainframe 10. The signal control panel 4 serves to process the signal from the external device 11 and to connect to a main board and a media player of the computer mainframe 10, and to support the signal connection and transmission between the external device 11 and the computer mainframe 10.

A wire winder 5 serves to reel or release a signal transmission cable 50 therein. As shown in FIG. 4, one end of the signal transmission cable 50 is connected to the connector 3, and the other end thereof is connected to the signal control panel 4.

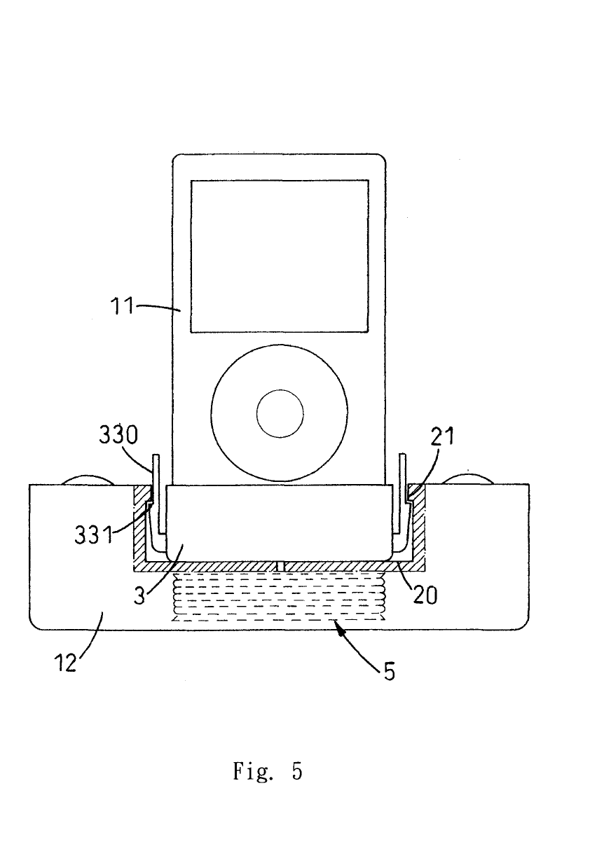

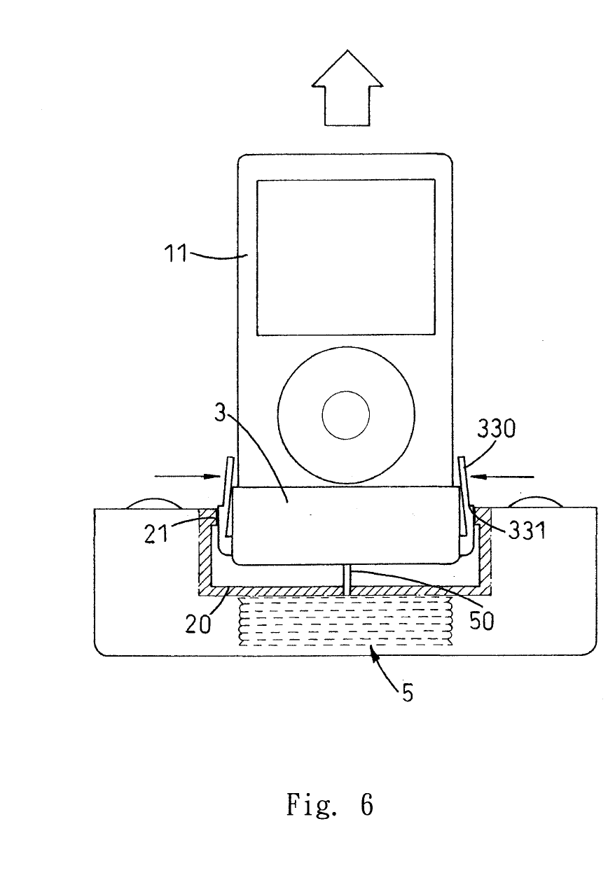

Through above description, as shown in FIG. 5, a user can connect an external device 11 to the connector 3 and then install the connector 3 to the arranging portion 2 by buckling the arranging portion 2 with the installing portion 33 of the connector 3. And through the process of the signal control panel 4, a signal communication between the external device 11 and the computer mainframe 10 is executable such as data downloading, data uploading, media playing, or other activities supported. While an external device 11 cannot be installed to the computer mainframe 10 because of limitation of space as shown in FIG. 3; or when a user is going to use an interface 110 provided by the external device 11, the external device 11 connected to the connector 3 can be dragged to a predetermined position through pressing the operating sheet 330 of the connector 3 to drive the installing portion 331 to leave the slot 21 of the arranging portion 2 as illustrated in FIG. 6. Meanwhile, the external device 11 can remain to be connected through the signal transmission cable 50 contained of the wire winder 5.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wire connection assembly for connecting a computer mainframe with an external device comprising: an arranging portion, a connector, a wire winder, and a signal control panel; the arranging portion, the wire winder, and the signal control panel compatible to a computer mainframe, and the connector compatible to the arranging portion;
wherein the wire winder serves to reel or release a signal transmission cable received therein, and one end of the signal transmission cable is connected to the connector, and the other end thereof is connected to the signal control panel.

2. The wire connection assembly for connecting a computer mainframe with an external device as claimed in claim 1, wherein the arranging portion, the wire winder, and the signal control panel are formed in the carrier seat installed to the computer mainframe.

3. The wire connection assembly for connecting a computer mainframe with an external device as claimed in claim 1, wherein the arranging portion, the wire winder, and the signal control panel are formed in a computer mainframe.

4. The wire connection assembly for connecting a computer mainframe with an external device as claimed in claim 1, wherein the arranging portion has a receiving hole, and the connector has a main portion compatible to the receiving hole, an insertion portion compatible to a mechanic specification of an external device, a guide portion compatible to an electric specification of the external device and an installing portion installable to or detachable from the arranging portion.

5. The wire connection assembly for connecting a computer mainframe with an external device as claimed in claim 4, wherein the arranging portion has a receiving hole and each of two opposite inner sides of the receiving hole has a slot, and the installing portion of the connector includes an operation sheet and a bulged resisting portion, the operation sheet serves to drive the resisting portion to cause the installing portion to be buckled to the slot so that the connector is installed in the receiving hole or the operation sheet drives the resisting portion to leave form the slot so that the connector is detached from the arranging portion.
